(19) United States
(12) Patent Application Publication
(10) Pub. No.: US 2026/0183665 A1
(43) Pub. Date: Jul. 2, 2026

(54) METHOD FOR CONTROLLING MOVEMENT OF VIRTUAL UNIT, ELECTRONIC DEVICE, AND MEDIUM

(71) Applicant: Shanghai Lilith Technology Corporation, Shanghai (CN)

(72) Inventors: Yining Li, Shanghai (CN); Yuwei Sun, Shanghai (CN)

(21) Appl. No.: 18/838,037

(22) PCT Filed: Jul. 28, 2023
(86) PCT No.: PCT/CN2023/109812

§ 371 Date: Aug. 13, 2024

(51) Int. Cl. A63F 13/577; A63F 13/56; A63F 13/803

(52) U.S. Cl. CPC A63F 13/577; A63F 13/56; A63F 13/803

(57) ABSTRACT

The present application relates to a method for controlling a movement of a virtual unit, an electronic device, and a medium. The method includes: receiving a movement instruction, where the movement instruction instructs a first virtual unit to move from a starting position to a target position; determining a second virtual unit within a predetermined range between the starting position and the target position; calculating a path from the starting position to the target position; reducing a collision radius of the first virtual unit and the second virtual unit respectively according to a predetermined ratio; and controlling the first virtual unit to move to the target position.

### TECHNICAL FIELD

The present application relates to the field of computer technologies, and in particular, to a method for controlling a movement of a virtual unit, an electronic device, and a medium.

### BACKGROUND

In most multiplayer online simulation games currently on the market, movable combat units are not designed with a blocking effect, and different combat units can clip through each other. This results in a large number of combat units possibly overlapping in the same position, affecting the visual experience of users. The design method that does not include the blocking effect affects the gameplay design to a certain extent. For example, it is difficult to control the upper limit of the number of combat units that attack a unit simultaneously. Due to too many overlapping units, detailed combat performances cannot be made, and the users cannot experience the delicate combat process. In other implementations in the art, even if the blocking effect is designed at the cost of a lot of computing power, there is no effective solution to deal with the blocking situation of the combat units while moving, and this leads to congestion of the combat units, resulting in poor user experience. In addition, if congestion of the combat units occurs, the system has to recalculate the movement path, further consuming a large amount of computing resources.

### SUMMARY

A main objective of the present application is to provide a method for controlling a movement of a virtual unit, an electronic device, and a medium that can reduce congestion.

A first aspect of the present application discloses a method used for an electronic device for controlling a movement of a virtual unit, where the method includes: receiving a movement instruction, where the movement instruction instructs a first virtual unit to move from a starting position to a target position; determining a second virtual unit within a predetermined range between the starting position and the target position; calculating a path from the starting position to the target position; reducing a collision radius of the first virtual unit and the second virtual unit respectively according to a predetermined ratio; and controlling the first virtual unit to move to the target position.

In a possible implementation of the first aspect, the reducing a collision radius of the first virtual unit and the second virtual unit respectively according to a predetermined ratio includes determining the predetermined ratio according to a motion state.

In a possible implementation of the first aspect, the motion state includes a moving state and a staying state, and the predetermined ratio in the moving state is not less than the predetermined ratio in the staying state.

In a possible implementation of the first aspect, the reducing a collision radius of the first virtual unit and the second virtual unit respectively according to a predetermined ratio includes determining the predetermined ratio according to the type of the virtual unit.

In a possible implementation of the first aspect, the method further includes determining a placement area of the first virtual unit.

In a possible implementation of the first aspect, the method further includes adjusting the placement area based on a distance between the first virtual unit and the target position.

In a possible implementation of the first aspect, when the distance between the first virtual unit and the target position is greater than a predetermined threshold, a first placement area is determined based on a first radius range of the target position.

In a possible implementation of the first aspect, the method further includes ignoring blocking of the second virtual unit in a moving state in the first placement area.

In a possible implementation of the first aspect, the method further includes, when the distance between the first virtual unit and the target position is less than or equal to a predetermined threshold, determining a second placement area based on a second radius range of the target position.

In a possible implementation of the first aspect, the second placement area is an area that avoids an original collision radius of the second virtual unit.

In a possible implementation of the first aspect, when there is no placement position in the second placement area, the movement is terminated.

A second aspect of the present application discloses an electronic device, including a memory in which a computer executable instruction is stored and a processor; when the computer executable instruction is executed by the processor, the device implements the method of the first aspect of the present application.

A third aspect of the present application discloses a computer readable medium, the computer readable medium stores one or more computer programs, and the one or more computer programs can be executed by one or more processors to cause the processor to implement the method of the first aspect of the present application.

A fourth aspect of the present application discloses a computer program product, including a computer program, and when the computer program is executed by a processor, the method of the first aspect of the present application is implemented.

According to the method for controlling the movement of the virtual unit, the electronic device, and the medium of the present application, after receiving an instruction instructing a first virtual unit to move from a starting position to a target position, a second virtual unit different from the first virtual unit within a predetermined range between a starting position and a target position is determined, a collision radius of the first virtual unit and the second virtual unit within the predetermined range is reduced respectively according to a predetermined ratio, a movement path is calculated, and the first virtual unit is controlled to move toward the target position according to the movement path. That is, after the first virtual unit receives the movement instruction, the collision radius of other virtual units that may be encountered on the movement path and the first virtual unit is reduced, so that the movement process of the first virtual unit is not blocked. In a game scene, a large number of virtual units can be moved smoothly to reduce congestion and save computing power.

### BRIEF DESCRIPTION OF DRAWINGS

In order to explain the technical solution of the present invention more clearly, the drawings needed to be used in the embodiments or description of the prior art are briefly introduced below. Obviously, the drawings in the following description are only some embodiments of the present invention. For a person of ordinary skill in the art, other drawings can be obtained based on these drawings without creative efforts.

FIG. 1 is a schematic diagram of an application scenario according to an embodiment of the present application;

FIG. 2 is a schematic flowchart of a method 200 for controlling a movement of a virtual unit according to an embodiment of the present application;

FIG. 3a is a schematic diagram of a virtual unit before movement according to an embodiment of the present application;

FIG. 3b is a schematic diagram of a virtual unit during movement according to an embodiment of the present application;

FIG. 4 is a schematic diagram of reducing a collision radius of a virtual unit according to a predetermined ratio according to an embodiment of the present application;

FIGS. 5a-5c are schematic diagrams of determining a placement position of a virtual unit according to an embodiment of the present application;

FIG. 6 is a schematic flowchart of a method 600 for determining a placement position of a virtual unit according to an embodiment of the present application; and

FIG. 7 is a schematic diagram of an electronic device 700 according to an embodiment of the present application.

### DETAILED DESCRIPTION OF DRAWINGS

The present application is further described below with reference to specific embodiments and drawings. It can be understood that the illustrative embodiments of the present disclosure include but are not limited to a virtual unit movement control method, an electronic device, and a medium. The specific embodiments described herein are only for explaining the present application, but not for limiting the present application. In addition, for convenience of description, only some but not all structures or processes related to the present application are shown in the drawings.

In order to make the objective, technical solutions, and advantages of the present application clearer, the embodiments of the present application are described in further detail below with reference to the accompanying drawings.

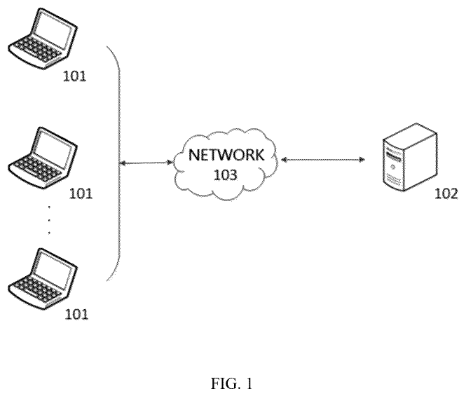

FIG. 1 is a schematic diagram of an application scenario according to an embodiment of the present application. This application scenario includes at least one client device 101 and at least one game server 102, and the client device 101 is connected to the game server 102 by using a network 103. The client device 101 may be any device having computing hardware, and the computing hardware is capable of supporting and executing a software application product corresponding to a game. The client device 101 may be, for example, a desktop computer, a notebook computer, a smart phone, a tablet computer, and a handheld game console. The network 103 may be a wireless network or a wired network. For example, the wireless network may be a wireless local area network (WLAN), a local area network (LAN), a cellular network, a 2G network, a 3G network, a 4G network, and a 5G network. In addition, different terminals can be connected to another terminal or can be connected to a server by using their own Bluetooth network or a hotspot network.

The software application product corresponding to a game includes but is not limited to a role-playing game (RPG), a simulation game (SLG), and an action game (ACT). The RPG game usually focuses on stories in which players play one or more characters, and the players need to complete tasks, adventures, explorations, etc. to promote the development of the game plot. The SLG game focuses on strategy and simulation, and players need to achieve game goals through reasonable strategic arrangements. In the SLG game, players need to manage resources, build buildings, formulate tactics, etc. to protect their territory or conquer other countries. The ACT game focuses on actions of players, and emphasizes the hit feedback, operation and timely feedback. The software application product corresponding to a game is not limited to a single one of the RPG game, the SLG game, and the ACT game, but can also be a combination of two or more of them.

In a virtual game scene, a user can control the movement of a virtual unit in the virtual game scene by using the client device 101 to move from a starting position to a target position. The virtual unit can be a game character with a 3D or 2D model (such as a walking character or a pet character) and a game prop (such as a vehicle, a tank, or a chariot), and a virtual unit participating in combat in the virtual game scene is called a combat unit. Usually, in implementations of the art, a blocking effect is not designed for the movement of the virtual unit, that is, the same position may be occupied by different virtual units, and different virtual units may clip through, which causes multiple virtual units to overlap at the same position, and leads to poor user perception. In other implementations of the art, even if the blocking effect is designed at the cost of a lot of computing power, there is no effective solution for the situation in which the virtual unit is blocked while moving, which causes congestion of the virtual unit and leads to poor user experience. In addition, if congestion of the virtual unit occurs, the system has to recalculate a movement path, and a large amount of computing resources is further consumed.

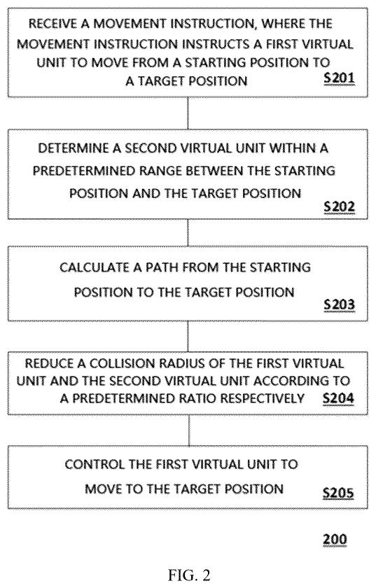

To solve the above problem, an embodiment of the present application provides a method 200 for controlling a movement of a virtual unit, which is applied to an electronic device. Referring to FIG. 2, the method 200 includes the following steps.

In S201, a movement instruction is received, and the movement instruction instructs a first virtual unit to move from a starting position to a target position.

The first virtual unit is one or more minimum mobile units in a game scene, such as a vehicle, a tank, a boat, or an airplane in a transportation vehicle. The first virtual unit can be a minimum mobile unit or multiple minimum mobile units that move together, such as a tank or a tank army. In some other examples, the first virtual unit may be a virtual game character, such as infantry or cavalry. The movement instruction may come from an input operation of a user on the client device 101, such as clicking, sliding, double-clicking and other operations on a touch screen.

In S202, a second virtual unit within a predetermined range between the starting position and the target position is determined.

The second virtual unit is one or more minimum mobile units in the game scene other than the first virtual unit. The second virtual unit may be a friendly unit or an enemy unit of the first virtual unit. In other examples, the second virtual unit may further be the minimum mobile unit in the game character controlled by a non-player, such as a virtual unit controlled by an NPC or AI. In addition, the second virtual unit may be in a staying state or a moving state. If the second virtual unit is in a moving state, a moving direction of the second virtual unit includes but is not limited to, a direction that is the same as or opposite to a moving direction of the first virtual unit. In some examples, the moving direction of the second virtual unit may further be a direction at any angle other than a direction the same as or opposite to the moving direction of the first virtual unit.

The predetermined range between the starting position and the target position may be a range related to a movement path between the starting position and the target position, such as a range covered by the movement path, or may include a range within a certain distance near the movement path, that is, a range covered by extending a certain distance along the normal direction of the movement path. The movement path may be a straight line, a curve, or a polyline. In some other examples, the predetermined range between the starting position and the target position is not limited to the range related to the movement path. For example, the predetermined range may include all coordinate locations in a rectangle, where the starting position and the target position are used as diagonal vertices of the rectangle.

In S203, a path from the starting position to the target position is calculated.

The movement path of the first virtual unit from the starting position to the target position is calculated, and the first virtual unit is controlled to move toward the target position. The movement path can be calculated based on a pathfinding algorithm. In some examples, the pathfinding algorithm includes the Reciprocal Velocity Obstacles (RVO) algorithm, the Detour Crowd algorithm, or the Particle Swarm Optimization algorithm.

In S204, a collision radius of the first virtual unit and the second virtual unit is reduced respectively according to a predetermined ratio.

The collision radius of the first virtual unit and the second virtual unit is reduced respectively according to the predetermined ratio. In the present invention, there may be multiple predetermined ratios, and the predetermined ratios for the first virtual unit and the second virtual unit may be different, or the predetermined ratios for different types of virtual units may be different, or the predetermined ratios for virtual units in different motion states may be different. Virtual units in the game can be of various shapes, and the collision volume can be an irregular volume. In some examples, to reduce the load on a server, the collision volume can be simplified to a sphere, a cuboid, or a circle in a two-dimensional plane. For example, a sphere or circle can be used to represent the collision volume of a virtual unit, so that the collision radius can be used to measure the size of the virtual unit. In a 3D game, the radius of a sphere can be used as the collision radius. In a 2D game, the radius of a circle projected by a virtual unit on a two-dimensional plane can be used as the collision radius.

When the collision radius of the first virtual unit and the collision radius of the second virtual unit are respectively reduced according to the predetermined ratio, the probability that the first virtual unit is blocked by the second virtual unit when moving on the movement path between the starting position and the target position is greatly reduced, and congestion is reduced. The reduction ratio of the collision radius of the first virtual unit and the reduction ratio of the collision radius of the second virtual unit may be the same or different.

In some implementations, the predetermined ratio for reducing the virtual unit may be determined according to the type to which the virtual unit belongs. In some examples, corresponding predetermined ratios may be set for virtual units corresponding to different types. For example, different predetermined ratios can be set for virtual units of two different types: a vehicle and a tank. For a type of virtual unit with a larger collision radius, a smaller predetermined ratio can be set. For example, there are virtual units of type A and type B, and the collision radius of the virtual unit of type B is larger (2 times the collision radius of the virtual unit of type A), the predetermined ratio of the virtual unit of type B can be set to 30%, that is, the reduced collision radius is 70% of the original collision radius. The predetermined ratio of the virtual unit of type A is set to 50%, that is, the reduced collision radius is 50% of the original collision radius.

In S205, the first virtual unit is controlled to move to the target position.

The order in which the steps S201-S205 are performed is not limited to the order of numbers. For example, S202 may occur before S203, that is, the second virtual unit within the predetermined range is first determined and then the movement path is calculated. Alternatively, S203 can occur before S202, that is, the path is calculated first and then the predetermined range is determined according to the movement path, and the second virtual unit is further determined, or the path first is calculated and then the second virtual unit in the predetermined range is directly determined. For another example, S204 may occur before S205, or S205 may occur before S204. In a case in which S204 occurs before S205, before the first virtual unit moves from the starting position to the target position, the collision radius of the first virtual unit and the second virtual unit is reduced respectively, the first virtual unit and the second virtual unit maintain a reduced state during the movement, so that it can ensure that the first virtual unit and the second virtual unit are not blocked during the movement. In a case in which S205 occurs before S204, the first virtual unit is moved according to the path, and then the collision radius of the first virtual unit and the second virtual unit is reduced respectively when the first virtual unit is blocked during the movement to continue moving forward. The calculation of reduction of the collision radius is real-time. When the blocking is lifted, the first virtual unit and the second virtual unit return to their original collision radius.

In the method 200, after receiving an instruction instructing a first virtual unit to move from a starting position to a target position, a second virtual unit that is different from the first virtual unit is determined within a predetermined range between the starting position and the target position, a collision radius of the first virtual unit and the second virtual unit within the predetermined range is reduced respectively according to a predetermined ratio, a movement path is calculated, and the first virtual unit is controlled to move to the target position according to the movement path. That is, after the first virtual unit receives the instruction for movement, the collision radius of other virtual units that may be encountered on the movement path and the first virtual unit is reduced respectively, so that the movement process of the first virtual unit is not blocked. In the game scene, a large number of virtual units can move smoothly, and congestion is reduced, so that the increase in computing power load caused by congestion is further reduced.

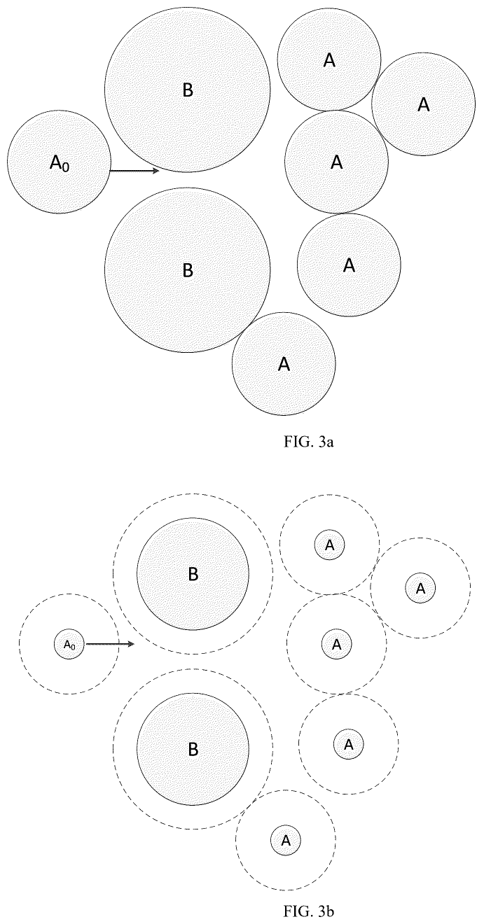

In order to better illustrate the method 200, FIG. 3a is a schematic diagram before a virtual unit moves according to an embodiment of the present application. FIG. 3b is a schematic diagram when a virtual unit moves according to an embodiment of the present application.

In a scenario of FIG. 3a, there are multiple virtual units of type A and virtual units of type B. An original collision radius of the virtual unit of type A is smaller than an original collision radius of the virtual unit of type B. In addition, a certain virtual unit of type A, that is, A₀ (a first virtual unit) in the figure, is planned to move from a current original position to a target position C. Because the space between the current position and the target position C is occupied by another virtual unit (that is, a second virtual unit), according to the prior art, the virtual unit A₀ cannot move to the target position C due to the blocking on the movement path. Other virtual units such as virtual units of type B between the virtual unit A₀ and multiple other virtual units of type A cannot be moved. In this case, congestion is caused.

In FIG. 3b, after reducing the collision radius of all virtual units between the starting position and the target position according to a certain proportion, there is ample movement space between the starting position and the target position. The dotted line represents the original collision radius of the virtual unit before reduction, and the solid line represents the collision radius of the virtual unit after reduction. In this case, the virtual unit A₀ can pass through the virtual unit of type B and multiple other virtual units of type A to reach the target position C. In this way, congestion is avoided.

In some implementations, a predetermined ratio may be determined according to a motion state to reduce the collision radius of the first virtual unit and the second virtual unit. The motion state includes a moving state and a staying state. The moving state indicates that the virtual unit moves at a certain speed, and the staying state indicates that the virtual unit stays at the current position, or hovers near the current position at a low moving speed. Then, considering that the first virtual unit is always in a moving state, predetermined ratios in the two motion states are generated according to the motion state of the second virtual unit, that is, when the second virtual unit is in the staying state, the first virtual unit is reduced according to a first predetermined ratio, and the second virtual unit is reduced according to a second predetermined ratio; when the second virtual unit is in the moving state, the first virtual unit is reduced according to a third predetermined ratio, and the second virtual unit is reduced according to a fourth predetermined ratio. The first predetermined ratio may be the same as the second predetermined ratio, or may be different from the second predetermined ratio. Further, the predetermined ratio in the moving state is not less than the predetermined ratio in the staying state. Specifically, the predetermined ratio corresponding to the first virtual unit and the second virtual unit when the second virtual unit is in the moving state is not less than the predetermined ratio corresponding to the first virtual unit and the second virtual unit when the second virtual unit is in the staying state, that is, the third predetermined ratio is not less than the first predetermined ratio, and the fourth predetermined ratio is not less than the second predetermined ratio.

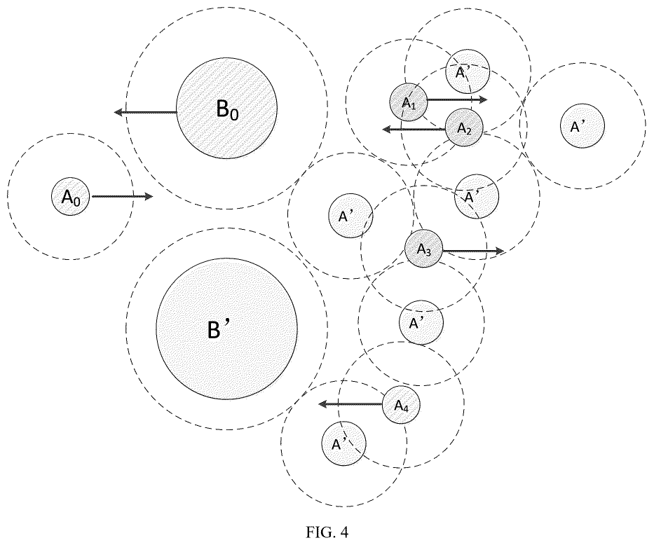

FIG. 4 is a schematic diagram of reducing a collision radius of a virtual unit according to a predetermined ratio according to an embodiment of the present application. In a scenario in FIG. 4, a virtual unit A₀ (that is, a first virtual unit) needs to move from a current position to a target position in the direction of the arrow. In this scenario, there is also a virtual unit B′ in a staying state, multiple virtual units A′ in the staying state, a virtual unit B₀ in the moving state, and virtual units A₁, A₂, A₃, and A₄ in the moving state. The moving directions of the virtual units A₁-A₄ and B₀ in the moving state may be different. FIG. 4 further shows the size of the original collision radius (dashed-line box) of each virtual unit and the size of the reduced collision radius (solid-line box). It can be learned that the predetermined ratios of virtual units of the same type are different in the moving state and the staying state. The person skilled in the art can understand that the type and number of virtual units in FIG. 4 are only illustrative. In some embodiments, other types of virtual units may be included, and the number of multiple virtual units of one type in one motion state may be not quite equal to the number of multiple virtual units of another type in another motion state.

Table 1 shows the ratio of the reduced collision radius of each virtual unit in FIG. 4 to the original collision radius. That is, the ratio of the reduced collision radius of the virtual unit to the original collision radius is obtained by subtracting the predetermined ratio corresponding to the virtual unit from 1. From the perspective of A₀, the reduced collision radius of the virtual units A₁-A₄ in the moving state is 30% of the original collision radius, the reduced collision radius of the virtual unit A′ in the staying state is 35% of the original collision radius, the reduced collision radius of the virtual unit B₀ in the moving state is 50% of the original collision radius, and the reduced collision radius of the virtual unit B′ in the staying state is 70% of the original collision radius. In the example of FIG. 4, for virtual units belonging to the same type A, the reduced collision radius of the virtual units A₁-A₄ in the moving state is smaller than the reduced collision radius of the virtual unit A′ in the staying state. For virtual units belonging to the same type B, the reduced collision radius of the virtual unit B₀ in the moving state is smaller than the reduced collision radius of the virtual unit B′ in the staying state. In other words, for the same type of virtual unit, the predetermined ratio of reduction of the virtual unit in the moving state is not less than the predetermined ratio of reduction of the virtual unit in the staying state.

TABLE 1
The ratio of the reduced collision radius of each virtual
unit to the original collision radius in FIG. 4

| A₀-A₄ | A′ | B₀ | B′ |
|---|---|---|---|
| 30% | 35% | 50% | 70% |

In FIG. 4, the initial positions of the multiple virtual units A′ and the virtual units B′ in the staying state do not overlap, while the initial positions of the virtual units A₁-A₄ in the moving state and the multiple virtual units A′ in the staying state overlap. In this case, when reducing the collision radius of the virtual unit, the position of the reduced virtual unit can be adjusted. For example, in FIG. 4, A₁ of the solid line box can be adjusted to be located at any position within the original dashed line box, and A′ of the solid line box of the virtual units staying nearby can be adjusted to be located at any position within the original dashed line box. In this way, overlapping is avoided. This adjustment can be implemented in a client device. After the client device calculates the adjusted positions of each virtual unit, and reports the relevant data to the server, and there is no need to perform calculation by using the server, so that the computing load of the server is reduced.

Table 2 shows the ratio of the reduced collision radius of each virtual unit to the original collision radius according to an embodiment of the present application. When a virtual unit A₀ is in the moving state, it is assumed that there are other virtual units on the movement path between the starting position and the target position, that is, A₁ and B₁ in the moving state and A′ and B′ in the staying state, and these virtual units may collide with or block A₀. From the perspective of A₀, that is, A₀ is the first virtual unit, and other virtual units are the second virtual units, the ratio of the reduced collision radius of A₁ in the moving state to the original collision radius is 30%, and the ratio of the reduced collision radius of B₁ in the moving state to the original collision radius is 50%, while the ratio of the reduced collision radius of A′ in the staying state to the original collision radius is 35%, and the ratio of the reduced collision radius of B′ in the staying state to the original collision radius is 70%.

TABLE 2
The ratio of the reduced collision radius of each
virtual unit to the original collision radius

| Perspective | Move A₁ | Stay A′ | Move B₁ | Stay B′ |
|---|---|---|---|---|
| Move A₀ | 30% | 35% | 50% | 70% |
| Move B₀ | 30% | 35% | 40% | 40% |

When a certain virtual unit B₀ is in the moving state, it is assumed that there are other virtual units between the starting position and the target position, that is, A₁ and B₁ in the moving state and A′ and B′ in the staying state. These virtual units all may collide with or block B₀. From the perspective of B₀, that is, B₀ is the first virtual unit, and other virtual units are the second virtual units, the ratio of the reduced collision radius of B₁ in the moving state to the original collision radius is 40%, and the ratio of the reduced collision radius of A₁ in the moving state to the original collision radius is 30%, while the ratio of the reduced collision radius of A′ in the staying state to the original collision radius is 35%, and the ratio of the reduced collision radius of B′ in the staying state to the original collision radius is 40%. It can be learned that, for the collision combination of different types of virtual units, the virtual units are reduced according to different predetermined ratios. Specifically, the predetermined reduction ratio of B₁ and B′ from the perspective of the moving A₀ is smaller than the predetermined reduction ratio of B₁ and B′ from the perspective of the moving B₀, that is, B₀, B₁ and B′ are all virtual units of large collision radius, so when the virtual units collide with each other, the collision radius needs to be made smaller to avoid collision.

According to Table 2, regardless of whether it is from the perspective of A₀ or B₀, for virtual units of type A, the predetermined ratio of reduction (from 100% to 30%) of A₁ in the moving state is greater than the predetermined ratio of reduction (from 100% to 35%) of A′ in the staying state. For virtual units of type B, from the perspective of the moving A₀, the predetermined ratio of reduction (from 100% to 50%) of B₁ in the moving state is greater than the predetermined ratio of reduction (from 100% to 70%) of B′ in the staying state. From the perspective of the moving B₀, the predetermined ratio of reduction of B₁ in the moving state is equal to the predetermined reduction ratio of reduction B′ in the staying state (both are reduced from 100% to 40%). Therefore, it can be learned that, from the perspective of different first virtual units, for the second virtual units of the same type, the predetermined ratio of reduction of the second virtual unit in the moving state can be set to be greater than or equal to (that is, not less than) the predetermined ratio of reduction of the second virtual unit in the staying state, that is, when two virtual units in the moving state block each other, the collision radius of the two virtual units becomes smaller, so that the two virtual units can pass the movement path more leisurely, and congestion is avoided.

Table 2 shows the reduced ratios of other virtual units from the perspective of the virtual units A₀ and B₀ in the moving state. When the virtual unit A₀ or B₀ is in the staying state, other virtual units can maintain the original collision radius.

In some embodiments, the virtual unit movement control method of the present application further includes determining a placement area of the first virtual unit. Because the movement state of each virtual unit in the game scene can change dynamically, there may be other virtual units near the target position, and blocking is caused, resulting in insufficient space to accommodate the collision radius of the first virtual unit, and the first virtual unit cannot be placed. Therefore, it is necessary to find a position in which the virtual unit can be placed within a certain range near the target position, and this range is the placement area. The placement position is a position that is in the placement area and that can accommodate the first virtual unit of the original collision radius. In order to save computing power resources, the placement area can be adjusted after the first virtual unit receives the movement instruction or during the movement. Because the placement areas have different sizes, different calculation amounts are required for calculation to find the placement position. In some examples, the placement area may be adjusted when a movement instruction is received, or when the distance between the first virtual unit and the target position is less than or equal to a predetermined threshold during movement. The placement position can be corrected at high frequency in real time according to the distance between the first virtual unit and the target position, or multiple predetermined threshold distances can be set according to the distance between the first virtual unit and the target position, and the placement position is corrected only when the above distance is satisfied with each threshold distance, thereby avoiding high-frequency corrections by the server and reducing the amount of calculation.

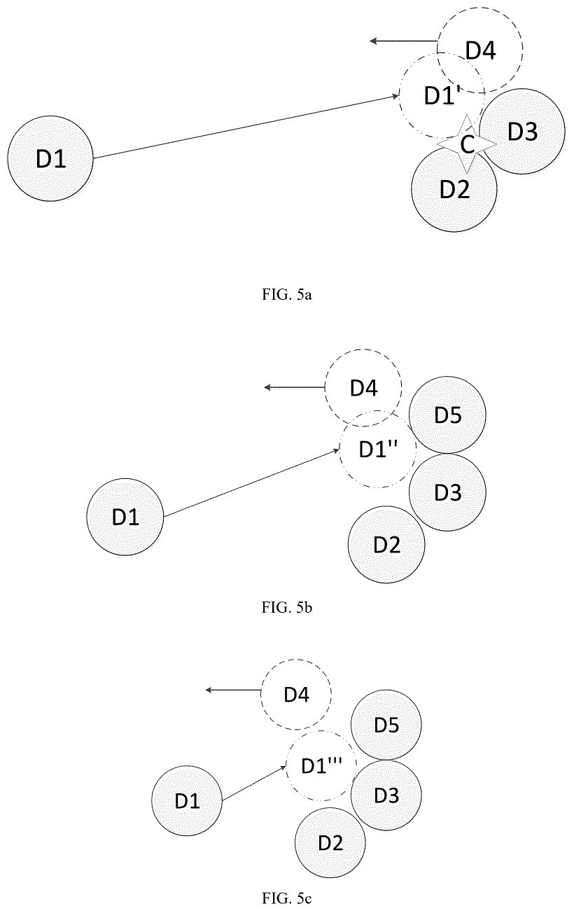

FIGS. 5a-5c show schematic diagrams of determining a placement position of a virtual unit according to an embodiment of the present application. A virtual unit D1 receives a movement instruction and needs to move to a target position C.

FIG. 5a is a schematic diagram of determining a placement position after receiving a movement instruction or during movement. In the example of FIG. 5a, the virtual unit D1 is far away from the target position C, for example, 100 meters. Near the target position C, there are virtual units D2 and D3 in a staying state and a virtual unit D4 in a moving state. Because the virtual unit D4 is in the moving state, blocking of the virtual unit D4 can be ignored, a placement position can overlap with D4. In addition, because the virtual units D2 and D3 are in the staying state, the virtual units D2 and D3 can be regarded as blocking, the placement position does not overlap with D2 and D3. The consideration at this stage is that the first virtual unit is still far away from the target position, and the virtual units in the moving state near the target position may leave, and therefore the blocking effect of the virtual unit in the moving state is not considered, so that the computational burden is reduced.

For determining the placement area, in addition to considering the blocking near the target position, a circular range of a placement radius with the target position as the center can be also considered. That is, only the position that can be placed is found within the circular range of the placement radius to reduce the calculation amount of the server. If there is blocking within the circular range of the placement radius and no position can be found for placement, an instruction indicating that the target position cannot be reached can be returned to the virtual unit D1, and the movement is terminated, and the virtual unit D1 stays in place.

In FIG. 5a, near the target position C (for example, the placement radius is 30 meters), regardless of the blocking of the moving virtual unit D4, the determined initial placement position is shown as D1′. The target position is updated to D1′. Determining the initial placement position can facilitate path calculation and subsequent confirmation of the final placement position.

FIG. 5b is a schematic diagram of determining a placement position during movement to the updated target position D1′. In the example of FIG. 5b, the virtual unit D1 is closer to the target position, for example, 30 meters. In this case, there are virtual units D2, D3, and D5 in the staying state and a virtual unit D4 in the moving state near the target position. Because the virtual unit D4 is in the moving state, the blocking of the virtual unit D4 can be ignored, the placement position can overlap with D4. In addition, because the virtual units D2, D3, and D5 are in the staying state, the virtual units D2, D3, and D5 can be regarded as blocking, the placement position does not overlap with D2, D3, and D5. Determining the first placement area can facilitate path calculation and subsequent confirmation of the final placement point.

In FIG. 5b, near the target position (for example, within the placement area with a placement radius of 30 meters), the blocking of the moving virtual unit D4 is ignored, the current placement position is determined as D1″. The target position is updated synchronously to the coordinates of D1″.

FIG. 5c is a schematic diagram of determining a placement position during the movement to the updated target position D1″. In the example of FIG. 5c, the virtual unit D1 is closer to the target position, for example, 5 meters. There are virtual units D2, D3, and D5 in the staying state and a virtual unit D4 in the moving state near the updated target position. Although the virtual unit D4 is in the moving state, in this case, the virtual unit D4 is also regarded as blocking, the placement position does not overlap with D4. In addition, because the virtual units D2, D3, and D5 are in the staying state, the virtual units D2, D3, and D5 can be regarded as blocking, the placement position does not overlap with D2, D3, and D5. The consideration at this stage is that the first virtual unit is about to approach the target position, and the blocking effect of the virtual unit in the moving state near the target position needs to be considered.

In FIG. 5c, near the updated target position (for example, the placement radius is 10 meters), the moving or staying virtual units are regarded as blocking, and the determined final placement position is shown as D1″.

It is worth mentioning that the sizes of the virtual units in the moving state in FIGS. 5a-5b are for illustration only. In the process of determining the placement position, in some examples, the placement position may be calculated based on the original collision radius of each virtual unit. In some other examples, when the first virtual unit is far away from the target position (such as FIGS. 5a-5b), the placement position can be determined based on the reduced collision radius of each virtual unit in order to update the target position and facilitate calculation and correction of the movement path. When the first virtual unit is close to the target position (for example, FIG. 5c), the final placement position can be determined based on the original collision radius of each virtual unit.

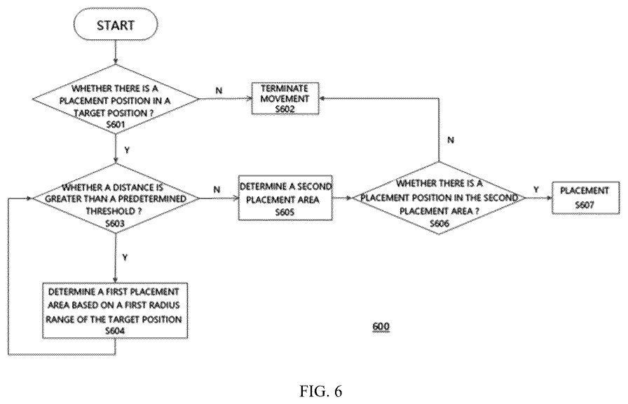

FIG. 6 is a schematic flowchart of a method 600 for determining a placement position of a virtual unit according to an embodiment of the present application. The method 600 includes the following steps.

In S601, whether there is a placement position in a target position is determined.

After receiving a movement instruction, it can be determined whether there is a placement position within a placement radius range of a target position. If no position that can be placed can be found within this range, for example, within the placement radius of the target position, all the positions are occupied by virtual units in a staying state, enter S602. In S602, an instruction that the target position cannot be reached can be returned to a first virtual unit, the movement of the first virtual unit is terminated, and the first virtual unit stays in place.

If the placement position can be found within this range, enter S603.

In S603, it is determined whether a distance between the first virtual unit and the target position is greater than a predetermined threshold. If yes, enter S604. In S604, a first placement area is determined based on a first radius range of the target position. The first placement area is an area including a possible placement position of the first virtual unit determined based on S604. The predetermined threshold can be flexibly set according to an actual situation, such as 5 meters or 10 meters.

In calculating the first placement area, the moving virtual unit can be regarded as unblocking. After the first placement area is determined, a certain position in the first placement area can be set as the updated target position. In some examples, a certain position in the first placement area other than the position occupied by the virtual unit in the staying state may be set as the updated target position.

As the first virtual unit moves, the distance between the current position of the first virtual unit and the updated target position can be compared with the predetermined threshold again according to changes in the moving distance or moving time until the distance between the two is less than equal to the predetermined threshold, enter S605. For example, when the distance between the first virtual unit and the updated target position is 50 meters, 30 meters, or at a predetermined time interval of movement (such as 10 seconds), the first placement area can be updated according to the state of each virtual unit near the updated target position.

If the distance between the first virtual unit and the target position is not greater than the predetermined threshold, enter S605. If the distance between the first virtual unit and the target position is less than or equal to the predetermined threshold, it indicates that the starting position of the first virtual unit is closer to the target position, or the first virtual unit is closer to the target position after receiving the movement instruction. In S605, a second placement area is determined. The second placement area may be determined based on a second radius range of the current target position. The second placement area is an area including a possible placement position of the first virtual unit determined based on S605. In calculating the second placement area, both the moving virtual unit and the staying virtual unit are regarded as blocking.

In the movement of the first virtual unit, a movement path may be calculated based on a reduced collision radius of each virtual unit. In a process of preparing for placement, the first placement area may be an area within a circle or volume within the first radius range and avoiding the reduced collision radius or the original collision radius of each virtual unit that is regarded as blocking. The second placement area may be an area within a circle or volume within the second radius range and avoiding the reduced collision radius or the original collision radius of each virtual unit that is regarded as blocking.

The second placement area is calculated based on the original collision radius of the second virtual unit.

In S606, it is determined whether there is a placement position in the second placement area.

In some embodiments, if the second placement area is an area within a circle or volume with a second radius range and avoiding the original collision radius of each virtual unit that is regarded as blocking, whether there is a placement position in the second placement area is directly checked. As mentioned above, other moving virtual units and staying virtual units in the second placement area are regarded as blocking. In this case, it is determined whether the space other than the block is enough for the first virtual unit to stay. If yes, enter S607. In S607, sufficient space that avoids the block is determined as the final placement area. The first virtual unit can be placed anywhere in the final placement area. Otherwise, enter S602, and the movement of the first virtual unit is terminated. The first virtual unit can stay at the current position. In some other examples, if there is no placement position in the second placement area, the second radius range can be increased, so that the first virtual unit searches for a placement position in an area farther away from the target position.

In some embodiments, if the second placement area is an area within a circle or volume with a second radius range and avoiding the reduced collision radius of each virtual unit that is regarded as blocking, after the second radius is determined, the collision radius of each virtual unit needs to be restored within a circle or sphere with the second radius as the radius. On this basis, whether there is a placement position in the second placement area is checked.

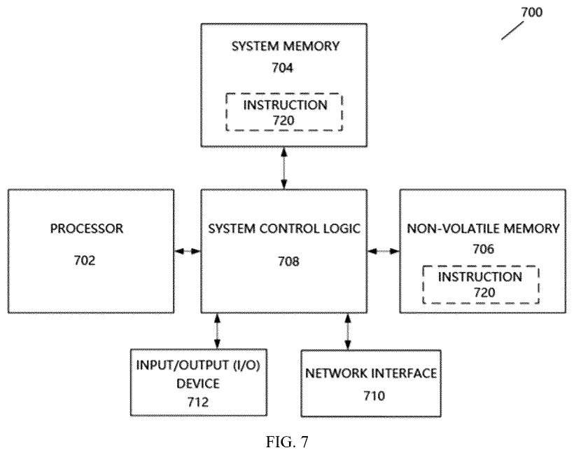

Referring now to FIG. 7, FIG. 7 is a block diagram of an electronic device 700 according to an embodiment of the present application. The device 700 may include one or more processors 702, system control logic 708 coupled to at least one of the processors 702, a system memory 704 coupled to the system control logic 708, and a non-volatile memory (NVM) 706 coupled to the system control logic 708, and a network interface 710 connected to the system control logic 708.

The processor 702 may include one or more single-core or multi-core processors. The processor 702 may include any combination of a general-purpose processor and a special-purpose processor (for example, a graphics processing unit, an application processor, and a baseband processor). In the embodiments herein, the processor 702 may be configured to perform the virtual unit movement control method according to one or more of the various embodiments shown in FIGS. 2-6.

In some embodiments, the system control logic 708 may include any suitable interface controller to provide any suitable interface to at least one of processors 702 and/or any suitable device or component in communication with the system control logic 708.

In some embodiments, the system control logic 708 may include one or more memory controllers to provide an interface to the system memory 704. The system memory 704 may be used to load and store data and/or an instruction. In some embodiments, the memory 704 of the device 700 may include any suitable volatile memory, such as a suitable dynamic random access memory (DRAM).

The NVM/memory 706 may include one or more tangible, non-transitory computer-readable media for storing data and/or instructions. In some embodiments, the NVM/memory 706 may include any suitable non-volatile memory such as a flash memory and/or any suitable non-volatile storage device, such as at least one of an HDD (Hard Disk Drive, Hard Disk Drive), a CD (Compact Disc, Compact Disc) drive, and a DVD (Digital Versatile Disc, Digital Versatile Disc) drive.

The NVM/memory 706 may include a portion of storage resources installed on the device 700, or may be accessed by the device but is not necessarily a part of the device. For example, the NVM/memory 706 may be accessed over the network via the network interface 710.

In particular, the system memory 704 and the NVM/memory 706 may include a temporary copy and a permanent copy of an instruction 720, respectively. The instruction 720 may include an instruction, and when the instruction is executed by at least one of the processors 702, the device 700 is caused to implement the methods shown in FIGS. 2 and 6. In some embodiments, the instruction 720, hardware, firmware, and/or software components thereof may additionally/alternatively be located in the system control logic 708, the network interface 710, and/or the processor 702.

The network interface 710 may include a transceiver for providing a radio interface for the device 700 to communicate with any other suitable device (such as a front-end module and an antenna) over one or more networks. In some embodiments, the network interface 710 may be integrated with other components of the device 700. For example, the network interface 710 may be integrated with at least one of the processor 702, the system memory 704, the NVM/memory 706, and a firmware device (not shown) having an instruction. When the instruction is executed by at least one of the processors 702, the device 700 implements one or more of the various embodiments illustrated in FIGS. 2-6.

The network interface 710 may further include any suitable hardware and/or firmware to provide a multiple-input multiple-output radio interface. For example, the network interface 710 may be a network adapter, a wireless network adapter, a telephone modem, and/or a wireless modem.

In one embodiment, at least one of the processors 702 may be packaged with logic for one or more controllers of the system control logic 708 to form a system in a package (SiP). In one embodiment, at least one of the processors 702 may be integrated on the same die with the logic for one or more controllers of the system control logic 708 to form a system on a chip (SoC).

The device 700 may further include an input/output (I/O) device 712. The I/O device 712 may include a user interface, so that a user can interact with the device 700. A peripheral component interface is designed, so that a peripheral component can also interact with the device 700. In some embodiments, the device 700 further includes a sensor for determining at least one of an environmental condition and location information associated with the device 700.

In some embodiments, the user interface may include, but is not limited to, a display (for example, a liquid crystal display and a touch screen display), a speaker, a microphone, one or more cameras (for example, a still image camera and/or a video camera), a flashlight (for example, a LED flash), and a keyboard.

In some embodiments, the peripheral component interface may include, but is not limited to, a non-volatile memory port, an audio jack, and a power interface.

In some embodiments, the sensor may include, but is not limited to, a gyroscope sensor, an accelerometer, a proximity sensor, an ambient light sensor, and a positioning unit. The positioning unit may further be a part of the network interface 710 or may interact with the network interface 710, to communicate with components of the positioning network (for example, a Global Positioning System (GPS) satellite).

It can be understood that the structure illustrated in the embodiment of the present invention does not constitute a specific limitation on the Bluetooth communication device 700. In other embodiments of the present application, the Bluetooth communication device 700 may include more or less components than shown in the figure, or combine some components, or split some components, or arrange different components. The components illustrated may be implemented in hardware, software, or a combination of software and hardware.

Program code may be applied to an input instruction to perform the functions described herein and to generate output information. The output information can be applied to one or more output devices in a known manner. For the purposes of the present application, a processing system includes any system having a processor such as, a digital signal processor (DSP), a microcontroller, an application specific integrated circuit (ASIC), or a microprocessor.

Program code may be implemented in a high-level procedural language or an object-oriented programming language to communicate with the processing system. When necessary, assembly language or machine language can also be used to implement program code. In fact, the mechanism described in this article is not limited to the scope of any particular programming language. In either case, the language may be a compiled or interpreted language.

One or more aspects of at least one embodiment may be implemented by a representative instruction stored on a computer-readable storage medium, the instruction represents various logic in a processor, and when the instruction is read by a machine, the machine is caused to perform the logic of the techniques described in this article. These representations, known as “IP cores”, may be stored on a tangible computer-readable storage medium and provided to multiple customers or production facilities for loading into the manufacturing machines that actually manufacture the logic or processors.

The present invention further provides a computer-readable medium. The storage medium stores one or more programs. The one or more programs can be executed by one or more processors to implement the virtual unit movement control method in one or more of the above embodiments.

One embodiment of the present application discloses a computer program product, including a computer program, and when the computer program is executed by a processor, the virtual unit movement control method in one or more of the above embodiments is implemented.

The implementation of the present application has been described above with specific embodiments. The person skilled in the art can easily understand other advantages and effects of the present application from the content disclosed in this description. Although the description of the present application is introduced with reference to the preferred embodiment, this does not mean that the features of the invention are limited to this embodiment. On the contrary, the purpose of introducing the invention with reference to the embodiments is to cover other options or modifications that may be extended based on the claims of the present application. In order to provide an in-depth understanding of the present application, the following description contains many specific details. The present application may be implemented without these details. Furthermore, some specific details are omitted in the description in order to avoid confusing or obscuring the focus of the present application. It should be noted that, as long as there is no conflict, the embodiments and features in the embodiments of the present application can be combined with each other.

Additionally, various operations are described as multiple discrete operations in a manner that is most helpful in understanding the illustrative embodiments; however, the order of description should not be construed to imply that the operations are necessarily order dependent. In particular, these operations do not need to be performed in the presentation order.

The terms “comprising,” “having,” and “including” are synonyms unless the context dictates otherwise. The phrase “A/B” means “A or B”. The phrase “A and/or B” means “(A and B) or (A or B)”.

As used herein, the term “module” or “unit” may refer to, be or include: an application specific integrated circuit (ASIC), an electronic circuit, a (shared, dedicated or group) processor and/memory that executes one or more software or firmware programs, a combinational logic circuit, and/or another suitable component that provides the functions described.

In some cases, the disclosed embodiments may be implemented in hardware, firmware, software, or any combination thereof. The disclosed embodiments may further be implemented as instructions carried on or stored on one or more transitory or non-transitory machine-readable (for example, computer-readable) storage media, which may be read or executed by one or more processors. For example, the instructions may be distributed over a network or via another computer-readable medium. Therefore, the machine-readable medium may include any mechanism for storing or transmitting information in a machine (for example, computer)-readable form, including but not limited to a floppy disk, an optical disk, a compact disc read-only memory (CD-ROM), a magneto-optical disk, a read-only memory (ROM), a random-access memory (RAM), an erasable programmable read-only memory (EPROM), an electrically erasable programmable read-only memory (EEPROM), a magnetic card or an optical card, a flash memory, or a tangible machine-readable memory for transmitting information over the Internet via electrical, optical, acoustic or other forms of propagated signals (for example, a carrier wave, an infrared signal, and a digital signal). Therefore, the machine-readable medium includes any type of machine-readable medium suitable for storing or transmitting an electronic instruction or information in a machine (for example, computer)-readable form.

In the drawings, some structural or methodological features are shown in specific arrangements and/or orders. However, it should be understood that such specific arrangement and/or ordering may not be required. In some embodiments, these features may be arranged in a different manner and/or order than shown in the illustrative figures. Additionally, the inclusion of the structural or methodological features in a particular figure is not meant to imply that such features are required in all embodiments, and in some embodiments, these features may not be included or may be combined with other features.

It should be understood that although the terms “first”, “second”, etc. may be used herein to describe various units or data, these units or data should not be limited by these terms. These terms are used solely to distinguish one feature from another feature. For example, a first feature could be termed a second feature, and similarly, a second feature could be termed a first feature, without departing from the scope of exemplary embodiments.

It should be noted that in this description, similar reference numerals and letters represent similar items in the following drawings. Therefore, once an item is defined in one drawing, definition and explanation do not need to be made for the item in subsequent drawings.

Although the present invention has been illustrated and described with reference to certain preferred embodiments of the present invention, a person of ordinary skill in the art should understand that various changes may be made in form and detail without departing from the teachings shall fall within the spirit and scope of the present invention.

1. A method used for an electronic device for controlling a movement of a virtual unit, wherein the method comprises:
receiving a movement instruction, wherein the movement instruction instructs a first virtual unit to move from a starting position to a target position;
determining a second virtual unit within a predetermined range between the starting position and the target position;
calculating a path from the starting position to the target position;
reducing a collision radius of the first virtual unit and the second virtual unit respectively according to a predetermined ratio; and
controlling the first virtual unit to move to the target position.

2. The method according to claim 1, wherein the reducing a collision radius of the first virtual unit and the second virtual unit respectively according to a predetermined ratio comprises determining the predetermined ratio according to a motion state.

3. The method according to claim 2, wherein the motion state comprises a moving state and a staying state, and the predetermined ratio in the moving state is not less than the predetermined ratio in the staying state.

4. The method according to claim 1, wherein the reducing a collision radius of the first virtual unit and the second virtual unit respectively according to a predetermined ratio comprises determining the predetermined ratio according to the type of the virtual unit.

5. The method according to claim 1, wherein the method further comprises determining a placement area of the first virtual unit.

6. The method according to claim 5, wherein the method further comprises adjusting the placement area based on a distance between the first virtual unit and the target position.

7. The method according to claim 6, wherein, when the distance between the first virtual unit and the target position is greater than a predetermined threshold, a first placement area is determined based on a first radius range of the target position.

8. The method according to claim 7, wherein the method further comprises ignoring blocking of the second virtual unit in a moving state in the first placement area.

9. The method according to claim 6, wherein the method further comprises, when the distance between the first virtual unit and the target position is less than or equal to a predetermined threshold, determining a second placement area based on a second radius range of the target position.

10. The method according to claim 9, wherein the second placement area is an area that avoids an original collision radius of the second virtual unit.

11. The method according to claim 9, wherein, when there is no placement position in the second placement area, the movement is terminated.

12. An electronic device, wherein the device comprises a memory in which a computer-executable instruction is stored and a processor, when the computer-executable instruction is executed by the processor, the device implements the method of claim 1.

13. A computer readable medium, wherein the computer readable medium stores one or more programs, and the one or more programs can be executed by one or more processors to implement the method of claim 1.

14. A computer program product, comprising a computer program, wherein, when the computer program is executed by a processor, the method of claim 1 is implemented.
